(19) United States
(12) Patent Application Publication
(10) Pub. No.: US 2012/0066454 A1
(43) Pub. Date: Mar. 15, 2012

(54) TERMINAL DEVICE, AND METHOD AND PROGRAM FOR STARTING TERMINAL DEVICE

(75) Inventor: Daisuke Fuji, Chiba (JP)

(73) Assignee: Access Co. Ltd, Tokyo (JP)

(21) Appl. No.: 13/321,814

(22) PCT Filed: May 17, 2010
(86) PCT No.: PCT/JP2010/058273

§ 371 Date: Nov. 21, 2011

(30) Foreign Application Priority Data
May 22, 2009 (JP) 2009 123939

(51) Int. Cl. G06F 12/16; G06F 12/00

(52) U.S. Cl. 711/115; 711/162; 711/E12.001; 711/E12.103

(57) ABSTRACT

Disclosed is a terminal device which is provided with: a starting processing means for executing a starting process of the terminal device; a non-volatile memory for storing data to be executed by the starting processing means; and a volatile memory for loading the data to be stored. The nonvolatile memory comprises: a read only area for storing read only data which does not need to be rewritten by a user; a rewritable area for storing rewritable data which is likely to be rewritten; and a hibernation area for storing a snap shot image being the result of execution of the read only data. The starting processing means is provided with a hibernation unit which loads the snap shot image to the volatile memory and a rewritable data execution unit which executes the rewritable data.

### TECHNICAL FIELD

The present invention relates a terminal device, such as a mobile phone, and a method and program for starting up the terminal device.

### BACKGROUND OF THE INVENTION

It is desirable that a time period (a user's sensible waiting time) elapsing from a time when a user presses a power key to a time when a terminal device becomes available is as short as possible. However, at present, a user's sensible waiting time at the time of start-up of a terminal device, such as a smart phone, is long, e.g., 60 seconds, which gives uncomfortable feeling to the user by forcing the user to wait for the time period. Furthermore, since enhancement of functions of the terminal device progresses year by year, the user's sensible waiting time at the time of start-up of the terminal device is increasing.

Recently, in order to reduce the start-up time of the terminal device, a method for starting up the terminal device using a hibernation function is being developed. In the hibernation function, data loaded into a RAM is stored in a non-volatile memory as a snapshot image at a given time point, e.g., at the time of power-off. By loading the snapshot image into the RAM at the time of start-up of the terminal device without change, the state of the RAM is restored rapidly.

Japanese Patent Provisional Publication No. 2008-165553A (hereafter, referred to as patent document #1) describes an example of starting up a terminal device using the hibernation function. In the terminal device described in patent document #1, an execution result of initialization processes of a power management function, a kernel, a device driver and an application program is stored in a non-volatile memory as warm boot image (a snapshot image) at the time of execution of a start-up process before shipment. It is possible to shorten the start-up time of the terminal device by loading the warm boot image into the RAM when the terminal device is started up. In patent document #1, it is also proposed to start such a start-up process when a battery is attached to the terminal device. With this configuration, it is possible to further shorten the user's sensible waiting time defined from pressing of the power key.

### SUMMARY OF THE INVENTION

However, in the start-up method described in patent document #1, the result of initialization process of the terminal device is obtained as a snapshot. Therefore, there is a case where data having a possibility of being changed by the user after the initialization process is restored to an initial state each time the terminal device starts up. For example, even when a wallpaper setting is changed by the user after start-up of the terminal device, the wallpaper is restored to the initial state stored as the snapshot because the terminal device is started up through the hibernation. For this reason, the user needs to make settings again or obtain again a snapshot image each time the terminal device starts up, which is very troublesome for the user.

The present invention is made in consideration of the above described circumstances. The object of the present invention is to provide a terminal device and a starting method and program capable of appropriately reflecting data changed by a user, while shortening a user's sensible waiting time.

To solve the above described problem, there is provided a terminal device, which includes a start-up processing means which executes a start-up process on a terminal device for which a hardware reset is conducted, a non-volatile memory which stores data to be executed by the start-up processing means, and a volatile memory into which the data stored in the non-volatile memory is loaded. The nonvolatile memory includes a read-only area which stores read-only data which does not need to be rewritten by a user of the terminal device, a rewritable area which stores rewritable data having a possibility of being rewritten by the user, and a hibernation area which stores a snapshot image being an execution result of the read-only data. The start-up processing means includes a hibernation unit which loads the snapshot image into the volatile memory, and a rewritable data execution unit which executes the rewritable data stored in the rewritable area.

With this configuration, for the read-only data repeatedly executed each time the start-up process is executed, the start-up by the hibernation using the snapshot image is executed, and for the data having a possibility of being rewritten after start-up, a process based on such data can be executed each time the start-up is executed. Therefore, it is possible to shorten the user' sensible waiting time and thereby to reflect the contents rewritten by the user when the terminal device is started up. As a result, it becomes possible to reduce the user's work for resetting and the deterioration of the storage by re-acquisition of the snapshot.

The start-up processing means may start the start-up process at a time when the hardware reset is conducted on the terminal device.

The terminal device may further include a battery which is detachably attachable to the terminal device, and the start-up processing means may start the start-up process at a time when the battery is attached to the terminal device. With this configuration, it becomes possible to start the start-up process without wasting the time elapsing form the time when the battery is attached to the terminal device to the time when the user conducts the operation for starting the terminal device. As a result, it becomes possible to shorten the user's sensible waiting time.

The start-up processing means may start the start-up process at a time when the power key is operated.

The terminal device may further include a display means which displays an image; and a power key for turning on the terminal device. The start-up processing means may further include a display means activation unit which activates the display means when the power key of the terminal device is pressed during execution of the start-up process. Such a configuration also enables the user to recognize that the start-up of the terminal device is started when the power key is pressed long during the start-up process. As a result, the user can be prevented from being confused.

The start-up processing means may further include a read-only data execution unit which executes the read-only data stored in the read-only area, and the snapshot image is data of the non-volatile memory after execution by the read-only data execution unit. The read-only data execution unit may execute the read-only data when the terminal device is started up for a first time.

The read-only data execution unit may execute the read-only data when the read-only data is changed. With this configuration, it is possible to obtain the snapshot image corresponding to the read-only data stored in the terminal device, and thereby to start up the terminal device appropriately.

The snapshot image may be stored in advance in the non-volatile memory at a time of factory shipment. With this configuration, it becomes possible to achieve quick start-up by hibernation at the first time start-up after factory shipment.

The rewritable data execution unit may further execute a process based on data stored in a SIM card detachably attachable to the terminal device. With this configuration, it becomes also possible to execute the proper start-up process based on the data stored in the SIM card at the time of exchange of IM cards.

According to the invention, there is provided a starting method for a time of hardware reset of a terminal device comprising a nonvolatile memory having a read-only area which stores read-only data which does not need to be rewritten by a user of the terminal device, a rewritable area which stores rewritable data having a possibility of being rewritten by the user and a hibernation area which stores a snapshot image being an execution result of the read-only data, and a volatile memory into which the data stored in the non-volatile memory is loaded. The method includes a hibernation step of loading the snapshot image into the volatile memory; and a rewritable data execution step of executing the rewritable data stored in the rewritable area.

Furthermore, according to the invention, a starting program for causing a computer to execute the steps of the above described starting method is provided.

As described above, according to the invention, it is possible to provide a terminal device, starting method and program configured to shorten the user's sensible waiting time and to appropriately reflecting data rewritten by a user.

### BRIEF DESCRIPTION OF THE DRAWINGS

FIG. 1 illustrates an outer appearance of a terminal device according to an embodiment of the invention.

FIG. 2 is a block diagram generally illustrating a configuration of the terminal device according to the embodiment of the invention.

FIG. 3 illustrates state transition of the terminal device according to the embodiment of the invention.

FIG. 4 is a flowchart illustrating a flow of a start-up process according to the embodiment of the invention.

### EMBODIMENTS FOR CARRYING OUT THE INVENTION

In the following, an embodiment of the present invention is explained with reference to the accompanying drawings.

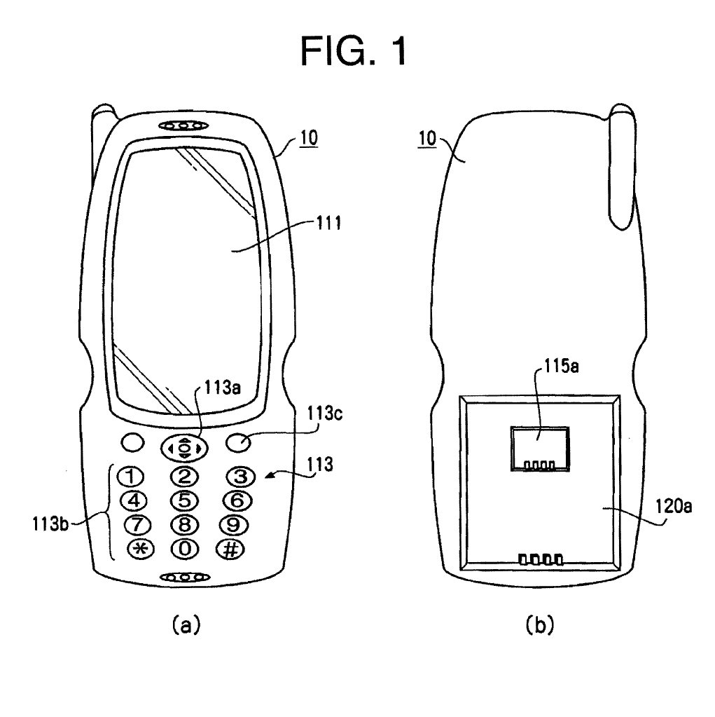

FIG. 1 illustrates an outer appearance of a terminal device 10 according the embodiment of the invention. FIG. 1(a) is a front view of the terminal device 10, and FIG. 1(b) is a rear view of the terminal device 10. Although in this embodiment the terminal device 10 is configured as a mobile phone, the terminal device 10 may be an another type of terminal device, such as, a smart phone, a PDA (Personal Digital Assistants), a PHS (Personal Handy phone System), a game machine, a digital home appliance, a car navigation, a desktop PC or a lap top PC. As shown in FIG. 1, the terminal device 10 is formed as a so-called straight type mobile phone in which an integrated body holds a display 111 and a user input device 113. However, the terminal device may be formed as a folding type, a rotational dual-axis hinge type, a cycloid type or a swing type.

As shown in FIG. 1(a), on the front face of the terminal device 10, the user input device 113 including a 5-way key 113a having four direction keys and an enter-key, a ten-key 113b and a power key 113c, and the display 111 are provided. It should be noted that the user input device 113 is not necessarily formed as a mechanical key including the 5-way key and the ten-key 113b, but may be configured as an another type of key, such as a membrane key or a touch panel. If the user input device 113 is formed, for example, with a touch panel, an operation screen corresponding to operation keys is configured by a screen formed integrally with the display 111 or a screen formed separately from the display 111.

FIG. 1(b) illustrates a situation where a battery 120, a SIM (Subscriber Identity Module) card 115 and a battery lid (not shown) are removed on the rear face of the terminal device 10. As shown in FIG. 1(b), on the rear face of the terminal device 10, a battery attachment part 120a is provided. The battery attachment part 120a is formed such that the battery can be detachably attachable thereto through an engagement nail. In the battery attachment part 120a, a SIM card attachment part 115a for attaching a SIM card 115 is formed as a recessed part. The terminal device 10 is used in a state where the SIM card 115 and the battery 120 are attached to the attachment parts 115a and 120a, respectively, and the battery lid (not shown) is attached thereto.

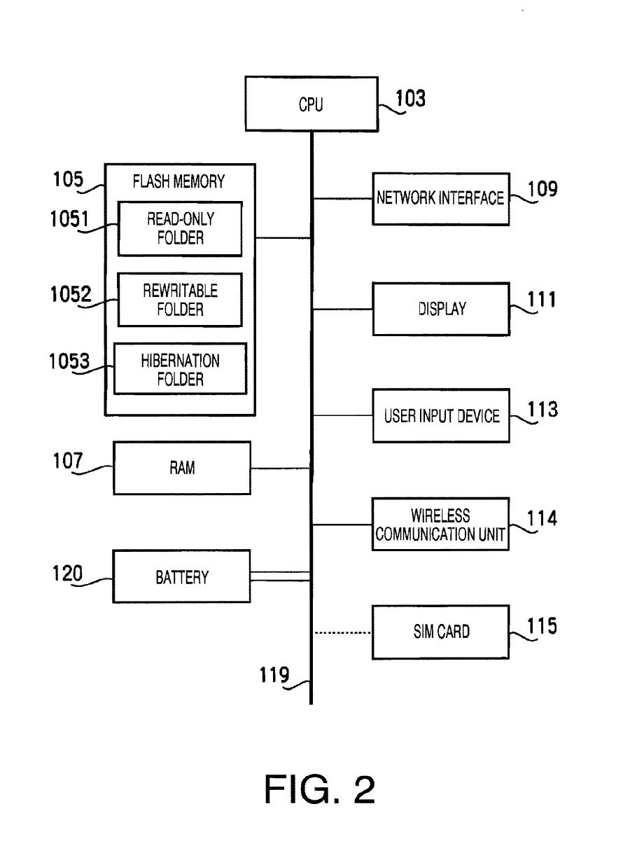

FIG. 2 is a block diagram generally illustrating a configuration of the terminal device 10. As shown in FIG. 2, the terminal device 10 includes a CPU (Central Processing Unit) 103, a flash memory 105, a RAM (Random Access Memory) 107, a network interface 109, the display 111, the user input device 113 and a wireless communication unit 114. These components constituting the terminal device 10 are connected to each other via a system bus 119. As described above, by attaching the SIM card 115 to the SIM card attachment part 115a, the SIM card 115 is connected to the components including the CPU 103 via the system bus 119. Furthermore, these components in the terminal device 10 are supplied power from the battery 120 attached to the battery attachment part 120a via a power line.

The CPU 103 communicates with the components in the terminal device 10, and totally controls the entire device 10. The flash memory 105 is a non-volatile memory storing various types of programs executed on the terminal device 10 and data. The flash memory 105 has a read-only folder 1051, a rewritable folder 1052, and a hibernation folder 1053. In the flash memory 105, data is stored in a folder corresponding to a property of the data. The RAM 107 is a volatile memory into which the various programs stored in the flash memory 105 are loaded. The various types of programs stored in the flash memory 105 are loaded into the RAM 107, and are executed by the CPU 103.

The network interface 109 is an interface for establishing a connection with an external network (e.g., the Internet) to transmit data to or receive data from the external network (initiating or receiving a call, transmission/reception of an e-mail, obtaining of Web contents, and etc.). The user input device 113 includes the various types of keys shown in FIG. 1(a), and receives various types of command operations by the user of the terminal device 10. The display 111 is a display device for displaying letters and images, and is configured, for example, by a LCD (Liquid Crystal Display) or an organic EL (Electro Luminescence). On the display 111, an operation status (a notification of reception of an incoming call) of the terminal device 10, data stored in the flash memory 105, and the Web contents obtained via the network interface 108 are displayed. The wireless communication unit 114 is a communication unit for communicating, by a narrow band wireless communication, with another terminal device. In the wireless communication unit 114, data is exchanged by wireless communication, such as Bluetooth™ or WiFi (wireless LAN).

The SIM card 115 is an IC card used in a GSM or W-CDMA mobile phone, and is an external storage device for storing information concerning a phone number of the user and the mobile phone career with which the user has made a contract. By attaching the SIM card 115 to the SIM card attachment part 115a, the terminal device 10 can be used by the phone number recorded in the card. When the SIM card 115 is inserted or withdrawn, it is necessary to securely turn off the SIM card 115 before inserting or withdrawing. This is because it is necessary to prevent the SIM card 115 itself or data stored in the SIM card 115 from being damaged, for example, due to an excessive current caused by inserting or withdrawing of the SIM card 115 in a state where the SIM card 115 is supplied with power. Therefore, as shown in FIG. 1(b), the terminal device 10 according to the embodiment is configured such that the SIM card 115 can be attached or removed only in the state where the battery 120 is removed and the power supply is securely cut off. The battery 120 is, for example, a secondary battery, which can be used repeatedly by electric charge, such as a lithium ion battery.

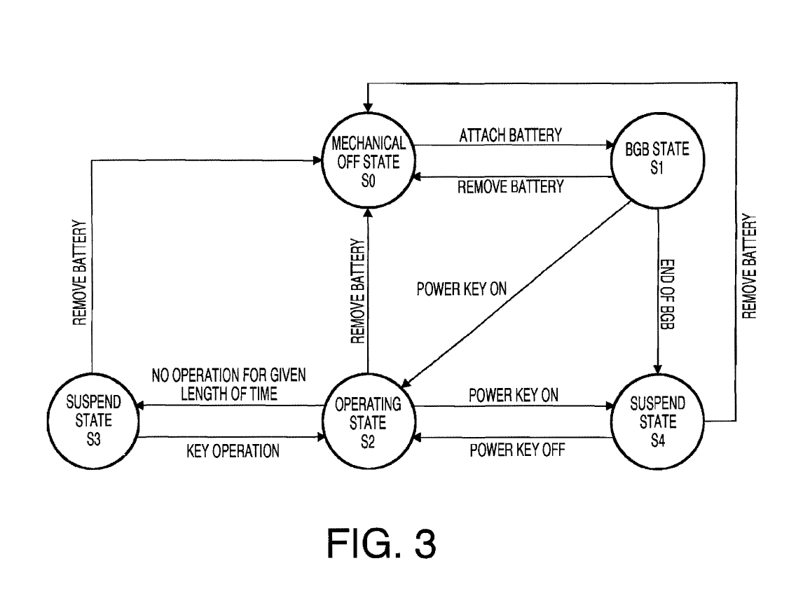

Hereafter, operation of the terminal device 10 is explained. FIG. 3 is a state transition diagram based on a power supply state of the terminal device 10. First, when the battery 120 is not attached to the terminal device 10, i.e., when no component in the terminal device 10 is supplied with power, the terminal device 10 is in a mechanical off state S0. When the battery 120 is attached to the terminal device 10 in the mechanical off state S0, the terminal device 10 moves to a BGB (Background Booting) state S1. In the BGB state S1, power is supplied to the CPU 103, the flash memory 105 and the RAM 107, and a background boot process (BGB) (which is described later) in the start-up process of the terminal device is executed.

When the BGB process of the terminal device 10 terminates in the BGB state S1, the terminal device 10 automatically moves to a suspend state S4 which is described later. On the other hand, when the user presses the power key 113c long, the terminal device 10 moves to an operating state S2 after the BGB process. In the operating state S2, power is supplied to each component in the terminal device 10, and the terminal device 10 is started up normally. By operating the user input device 113 in the operating state S2, it becomes possible to conduct various types of operations, such as initiation of an outgoing call, transmission of an e-mail or browsing of Web contents, on the terminal device 10.

When a non-operation state continues for a given length of time or more in the operating state S2, the terminal device 10 moves to a suspend state S3. The given length of time in this case is set by the user, and is stored in the flash memory 105. In the suspend state S3, power consumption can be reduced by lowering the clock frequency of the CPU 103. Furthermore, in the suspend state S3, power supply to the display 11 is stopped, and no information is displayed on the display 111. In the suspend state S3, power is supplied to the network interface 109 and the user input device 113, and reception of a call and a reception of an e-mail are executed. When one of the keys of the user input device 113 is pressed in the suspend state S3, the terminal device moves again to the operating state S2.

When the power key 113c is pressed long in the operating state S2, the terminal device 10 moves to the suspend state S4. The suspend state S4 is a normal power OFF state, and, in this state, power supply to the components other than the flash memory 105 and the RAM 107 is cut off, and the CPU 103 also stops. In this state, reception of an incoming call and an e-mail is not executed. When the power key 113c is pressed long in the suspend state S4, the terminal device 10 moves again to the operating state S2.

Next, the start-up process executed in the BGB state S1 is explained. In the terminal device 10, the battery 120 is removed when the hardware reset is necessary due to, for example, malfunction of the terminal device 10 or when the SIM card 115 is attached to the terminal device 10. In particular, when a user wants to operate a plurality of terminal devices based on a phone number and carrier information stored on a single SIM card 115, the battery 120 is frequently removed in order to replace the SIM card 115. In this embodiment, in consideration of such circumstances, the start-up process for shortening the user's sensible waiting time is executed at the time of start-up of the terminal device after hardware reset.

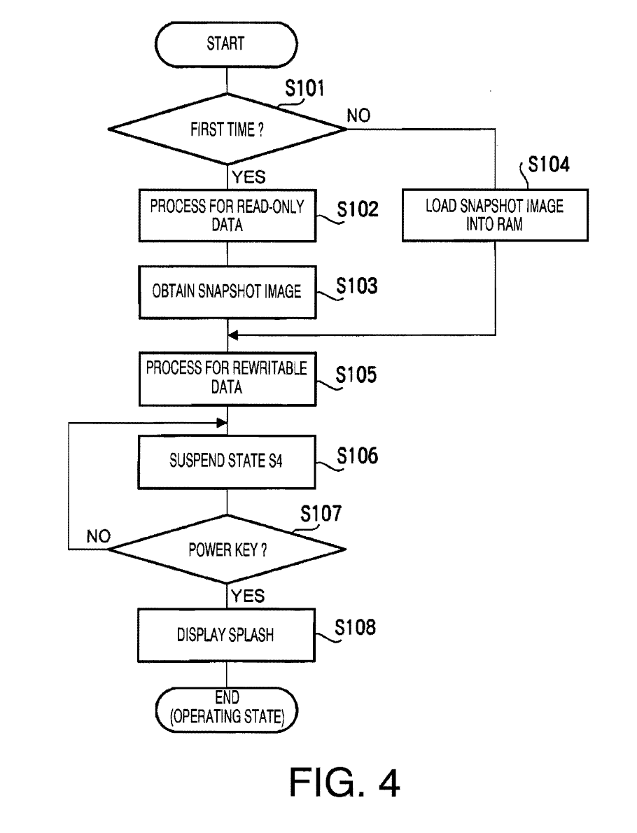

FIG. 4 is a flowchart illustrating the start-up process according to the embodiment. The start-up process is started when the battery 120 is attached to the battery attachment part 120a (i.e., when the hardware reset occurs). This process is executed by the CPU 103 by loading thee start-up program stored in the flash memory 105 into the RAM 103.

As shown in FIG. 4, first, it is determined whether the current start-up is the first time (S101). The term first time used herein means the case where the program is started for the first time after the terminal device 10 is shipped. In the flash memory 105, a flag indicating the number of times of start-up of the terminal device 10 is stored, and the terminal device 10 judges whether the current start-up is the first time based on the flag.

When it is judged that the current start-up is the first time (S101: YES), the various types of data stored in the read-only folder 1051 of the flash memory 105 is loaded into the RAM 107, and each process based on each of the various types of data is executed (S102). In the read-only folder 1051, the read-only data which does not need to be rewritten by the user is stored. The followings are examples of the read-only data stored in the read-only folder 1051.

Various types of programs (e.g., OS and System Components)

Information concerning applications preset at shipment (e.g. a mailer and a browser)

Identification number of the terminal device 10

Setting information of various types of keys on the user input device 113

Version information of software and hardware

Data for unifying differences between terminal devices 10 (e.g. offset data for sound volume having individual differences)

Setting information concerning a noise canceller

Communication speed of the wireless communication unit 114

Protocol used for e-mail

Acquisition interval of e-mail

Home screen of a browser

Splash image at time of start-up or termination

When the process based on the read-only data stored in the read-only folder 1051 is finished, the data loaded at this moment into the RAM 107 is obtained as a snapshot image (S103). The obtained snapshot image is stored in the hibernation folder 1053 of the flash memory 105. As a result, only data which does not need to be rewritten by the user (i.e., data which does not cause a problem even when the data is restored to the initial state each time the terminal device is started up) is stored in the flash memory 105 as a snapshot image.

Subsequently, the various types of data stored in the rewritable folder 1052 is loaded into the RAM 107, and the process based on each of the various types of data is executed (S105). In the rewritable folder 1052, rewritable data which would possibly be rewritten by the user of the terminal device 10 is stored. The followings are examples of the rewritable data stored in the rewritable folder 1052.

Theme of system

Wallpaper

Set language

Font type (font name and size)

E-mail data

Contact address data

Position information

Schedule information

ON/OFF information of wireless communication unit 114

Sound volume

Time elapsing until the device moves to the suspend state 3

Brightness of display 111

Call receipt sound, start up sound, termination sound and click sound

Information on silent mode, flight mode, normal mode

Information concerning application added by user

Date and time

Password

Orientation of terminal device 10

As described above, for the data having a possibility of being rewritten by the user, each process is executed after the snapshot image is obtained. In addition to the data stored in the rewritable folder 1052, the process based on the data stored in the SIM card 115 is also executed in 5105. The data stored in the SIM card 115 does not have a possibility of being rewritten by the user. However, with respect to the terminal device 10, data stored in the SIM card 115 can be changed by replacing the SIM card 115 with another one. Therefore, similarly to the data stored in the rewritable folder 1052, the data stored in the SIM card 115 should be executed after the snapshot image is obtained, and is treated as the rewritable data.

When the execution for the rewritable data stored in the rewritable folder 1052 and the data stored in the SIM card 115 is finished, the terminal device 10 moves to the suspend state S4 (S106). Then, the terminal device 10 waits until the power key 113s is pressed long (S107).

On the other hand, when the current start-up is the second time (S101: NO), the snapshot image stored in the hibernation folder 1053 of the flash memory 105 is loaded into the RAM 107 (S104). As described above, the snapshot image stored in the hibernation folder 1052 shows the execution result of the read-only data in the RAM 107. Therefore, by only copying the snapshot image to the RAM 107 without change, it becomes possible to bring the terminal device 10 to the state which is the same as the state defined at the end of execution of the read-only data.

Subsequently, the process based on the rewritable data stored in the rewritable folder 1052 and the SIM card 115 is executed (S105). When the execution of the rewritable data is finished, the terminal device 10 moves to the suspend state S4 (S106), and waits until the power key 113c is pressed long (S107). In the process according to the embodiment, the process executed during a period from the time when the battery 120 is attached to the time when the terminal device 10 moves to the suspend state S4, i.e., the process from S101 to S105, is a background boot process (BGB process).

When the power key 113c is pressed long in the suspend state S4 (S107: YES), the display 111 is activated, and the splash image is displayed on the display 111 (S108). Subsequently, an initialization process for the terminal device 10 is executed, and the terminal device 10 moves to the operating state S. Thus, the start-up process terminates.

While the terminal device moves to the suspend state S4 from the time when the battery 120 is attached to the terminal device 10 (i.e., during the BGB process), the user may press the power key 113s long. In such a case, when the power key 113c is pressed long, the display 11 is activated and the splash image is displayed on the display 111 as an interrupt process. In the state where the splash image is displayed on the display 11, the BGB process is executed. After the BGB process is finished, the steps of S106 to S107 are skipped, and the terminal device 10 moves to the operating state S2. As a result, the user is able to recognize that the terminal device 10 is stated up even when the power key 113c is pressed during the BGP process. That is, confusion can be avoided.

As described above, in the above described embodiment, the start-up process is started at the time when the battery 120 is attached to the battery attachment part 120a. Therefore, it is possible to start the start-up process without consuming away the time in which the user closes the battery lid. As a result, it becomes possible to shorten the user's sensible waiting time which elapses before the terminal device 10 becomes a usable state from the time when the user presses the power key 113c long. For the second time start-up or subsequent start-up of the terminal device 10, the startup time from the time when the battery 120 is attached can be shortened further by starting up the terminal device 10 with the snapshot image by hibernation.

In the terminal device 10 according to the embodiment, the pieces of data in the flash memory 105 are held in different folders depending on whether the data has a possibility of being rewritten by the user. As a result, it becomes possible to obtain the snapshot image before execution of the rewritable data by executing first the read-only data in the state where loading of the data stored in the rewritable folder 1052 is inhibited. For the read only-data repeatedly executed each time the terminal device 10 is started up, the start-up by the hibernation with the snapshot image is executed. For the data having a possibility of being rewritten by the user after start-up, the process based on such data is executed each time the terminal device starts up. As a result, it becomes possible to apply contents which were rewritten by the user to the terminal device 10 at the time of start-up of the terminal device 10. It becomes also possible to reduce the work for resetting by the user.

The foregoing is the embodiment of the invention. However, the present invention is not limited to the above described embodiment, and can be varied in various types of aspects. For example, in the above described embodiment, the start-up process is started in response to a trigger, i.e., a time point, caused when the battery 120 is attached. However, the invention is not limited to such an example. For example, on a terminal device having a key for hardware reset, the start-up process according to the embodiment may be started in response a trigger, i.e., a time point, caused when the hardware reset key is operated.

The start-up process according to the embodiment may be started at a time point when the power key 113c of the terminal device 10 is pressed long. In this case, when the battery 120 is attached in the mechanical OFF state S0, the terminal device 10 waits until the power key 113c is pressed long without starting the start-up process. Then, when the power key 113c is pressed long, the start-up process according to the embodiment is started. After the start-up process terminates, steps from S106 to S108 are skipped, and the terminal device 10 moves to the operating state S2. Even if such a configuration is employed, it is possible to start up the terminal device 10 in a short sensible waiting time while appropriately reflecting the change by the user in comparison with the conventional configuration.

Furthermore, in the above described embodiment, the read-only data stored in the read-only folder 1-51 is executed at the first time start-up, and the snapshot image is obtained. However, the present invention is not limited to such a configuration, and at the time of shipment of the terminal device 10, an appropriate snapshot image may be prepared in advance, and the generated snapshot image may be stored in the hibernation folder 1053 of the flash memory 105. With this configuration, it becomes possible to quickly start up the terminal device 10 at the first time start-up by the user.

In the above described embodiment, whether to execute the start-up by the hibernation is judged by the number of times of start-up of the terminal device 10. However, for example, the start-up by the hibernation may be determined in accordance with whether the snapshot image is stored in the hibernation folder 1053. At the start-up other than the first time start-up, steps S102 and S103 may be executed when data exists in the read-only folder 1051 of the flash memory 105. As a result, it becomes possible to start up the terminal device 10 with an appropriate snapshot even when firmware is changed.

1. A terminal device, comprising:
a start-up processing unit which executes a start-up process on a terminal device for which a hardware reset is conducted;
a non-volatile memory which stores data to be executed by the start-up processing unit; and
a volatile memory into which the data stored in the non-volatile memory is loaded,
the nonvolatile memory comprising:
a read-only area which stores read-only data which does not need to be rewritten by a user of the terminal device;
a rewritable area which stores rewritable data having a possibility of being rewritten by the user; and
a hibernation area which stores a snapshot image being an execution result of the read-only data,
the start-up processing unit comprising:
a hibernation unit which loads the snapshot image into the volatile memory; and
a rewritable data execution unit which executes the rewritable data stored in the rewritable area.

2. The terminal device according to claim 1, wherein the start-up processing unit starts the start-up process at a time when the hardware reset is conducted on the terminal device.

3. The terminal device according to claim 1,
further comprising a battery which is detachably attachable to the terminal device,
wherein the start-up processing unit starts the start-up process at a time when the battery is attached to the terminal device.

4. The terminal device according to claim 1,
further comprising:
a display unit which displays an image; and
a power key for turning on the terminal device,
wherein the start-up processing unit further comprises a display unit activation unit which activates the display unit when the power key of the terminal device is pressed during execution of the start-up process.

5. The terminal device according to claim 1,
further comprising a power key for turning on the terminal device,
wherein the start-up processing unit starts the start-up process at a time when the power key is operated.

6. The terminal device according to claim 1,
wherein:
the start-up processing means unit further comprises a read-only data execution unit which executes the read-only data stored in the read-only area; and
the snapshot image is data of the non-volatile memory after execution by the read-only data execution unit.

7. The terminal device according to claim 6,
wherein the read-only data execution unit executes the read-only data when the terminal device is started up for a first time.

8. The terminal device according to claim 6, wherein the read-only data execution unit executes the read-only data when the read-only data is changed.

9. The terminal device according to claim 1, wherein the snapshot image is stored in advance in the non-volatile memory at a time of factory shipment.

10. The terminal device according to claim 1,
wherein the rewritable data execution unit further executes a process based on data stored in a SIM card detachably attachable to the terminal device.

11. A starting method for a time of hardware reset of a terminal device comprising a nonvolatile memory having a read-only area which stores read-only data which does not need to be rewritten by a user of the terminal device, a rewritable area which stores rewritable data having a possibility of being rewritten by the user and a hibernation area which stores a snapshot image being an execution result of the read-only data, and a volatile memory into which the data stored in the non-volatile memory is loaded,
the method comprising:
a hibernation step of loading the snapshot image into the volatile memory; and
a rewritable data execution step of executing the rewritable data stored in the rewritable area.

12. The starting method according to claim 11, wherein the hibernation step is started at a time when the hardware reset is conducted on the terminal device.

13. The starting method according to claim 11, wherein the hibernation step is started at a time when a battery is attached to the terminal device.

14. The starting method according to claim 11,
further comprising an input step of receiving an operation for a power key by a user,
wherein the hibernation step is started when the operation for the power key is received by the input step.

15. The starting method according to claim 11,
further comprising:
a read-only data execution step of executing the read-only data;
a snapshot step of obtaining, as the snapshot image, the data in the volatile memory after execution of the read-only data execution step; and
a memory step of storing the snapshot image in the hibernation area,
wherein the read-only data execution step, the snapshot step and the memory step are executed before execution of the rewritable data execution step.

16. The starting method according to claim 15,
wherein the read-only data execution step, the snapshot step and the memory step are executed when the terminal device is started up for a first time.

17. The starting method according to claim 15,
wherein the read-only data execution step, the snapshot step and the memory step are executed when the read-only data is changed.

18. The starting method according to claim 11,
further comprising a display unit activation step of activating a display unit of the terminal device when a power key of the terminal device is operated during execution of the hibernation step or the rewritable data execution step.

19. The starting method according to claim 11,
wherein the rewritable data execution step further executes a process based on data stored in a SIM card which is detachably attachable to the terminal device.

20. A non-transitory computer readable medium having readable instruction stored thereon, which, when executed by a processor of a terminal device comprising a nonvolatile memory having a read-only area which stores read-only data which does not need to be rewritten by a user of the terminal device, a rewritable area which stores rewritable data having a possibility of being rewritten by the user and a hibernation area which stores a snapshot image being an execution result of the read-only data, and a volatile memory into which the data stored in the non-volatile memory is loaded, configures the processor to perform:
a hibernation step of loading the snapshot image into the volatile memory; and
a rewritable data execution step of executing the rewritable data stored in the rewritable area.
